(19) United States
(12) Patent Application Publication
(10) Pub. No.: US 2017/0211800 A1
(43) Pub. Date: Jul. 27, 2017

(54) LED LIGHTING SYSTEM

(71) Applicant: DAVINCI OPTO CORPORATION, NEW TAIPEI CITY (TW)

(72) Inventor: HUA-JUNG CHIU, NEW TAIPEI CITY (TW)

(21) Appl. No.: 15/007,361

(22) Filed: Jan. 27, 2016

(51) Int. Cl. F21V 29/83; F21V 23/00; F21V 21/30; F21V 29/70

(52) U.S. Cl. CPC F21V 29/83; F21V 29/70; F21V 23/004; F21V 21/30; F21Y 2115/10

(57) ABSTRACT

Disclosed is a LED lighting system, comprising a heat dissipator, a light emitting device, a lamp support and a base. The heat dissipator has a first carrying part, a second carrying part and a first receiving part. The light emitting device has a first fastening structure to fasten the first carrying part. The first carrying part has a locking part to lock the first receiving part. The base has a second fastening structure to fasten the second carrying part. It becomes more convenient to manually disassemble and assemble the elements of the LED lighting system without tools, which actually provides the convenience for the user.

### BACKGROUND OF THE INVENTION

1. Field of the Invention

The instant disclosure relates to an LED lighting system; in particular, to an LED lighting system that can be disassembled and assembled manually.

2. Description of Related Art

Currently, with respect to the common LED lamps including LED art lamps and products with LED lighting systems, when the lamp malfunctions, tools, such as screwdrivers, pincer pliers or the like, are necessary for disassembling the lamp. If a user does not have tools in hand, he can do nothing for disassembling the lamp until he finds the tool. Moreover, most LED lamps are installed at the ceiling or a high position on the wall, which has increased the difficulty for the user to disassemble or assemble the lamp.

### SUMMARY OF THE INVENTION

The instant disclosure provides an LED lighting system that can be disassembled and assembled without using tools. That is, a user can assemble or disassemble the elements of the LED lighting system manually.

The LED lighting system comprises a heat dissipator, a light emitting device, a lamp support and a base. The heat dissipator has a first carrying part, a second carrying part and a first receiving part. The light emitting device has a first fastening structure to fasten the first carrying part. The first carrying part has a locking part to lock the first receiving part. The base has a second fastening structure to fasten the second carrying part. It becomes more convenient to manually disassemble and assemble the elements of the LED lighting system without using tools, which effectively overcomes the above mentioned shortages of the prior art.

For further understanding of the instant disclosure, reference is made to the following detailed description illustrating the embodiments and embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1A shows a perspective drawing of one side of an LED lighting system of one embodiment in the instant disclosure.

FIG. 1B shows a perspective drawing of another side of an LED lighting system of one embodiment in the instant disclosure.

FIG. 2 shows a three-dimensional exploded view of an LED lighting system of one embodiment in the instant disclosure.

FIG. 3 shows an exploded view of a lamp holder of an LED lighting system of one embodiment in the instant disclosure.

FIG. 4 shows an assembly diagram for a back cover and an LED module of one embodiment in the instant disclosure.

FIG. 5 shows an assembly diagram for a heat dissipator and a front cover of one embodiment in the instant disclosure.

FIG. 6 shows an assembly diagram for a heat dissipator and a base plate of one embodiment in the instant disclosure.

FIG. 7 shows an assembly diagram for a clamp and a lamp holder of one embodiment in the instant disclosure.

FIG. 8 shows a perspective drawing of a clamping piece of an LED lighting system of one embodiment in the instant disclosure.

### DETAILED DESCRIPTION OF PREFERRED EMBODIMENTS

The instant disclosure is of an LED lighting system that can be disassembled and assembled without using tools. By manually fastening, rotating or plugging the elements, the user can easily disassemble and assemble the LED lighting system for exchanging or fixing the elements therein without using tools.

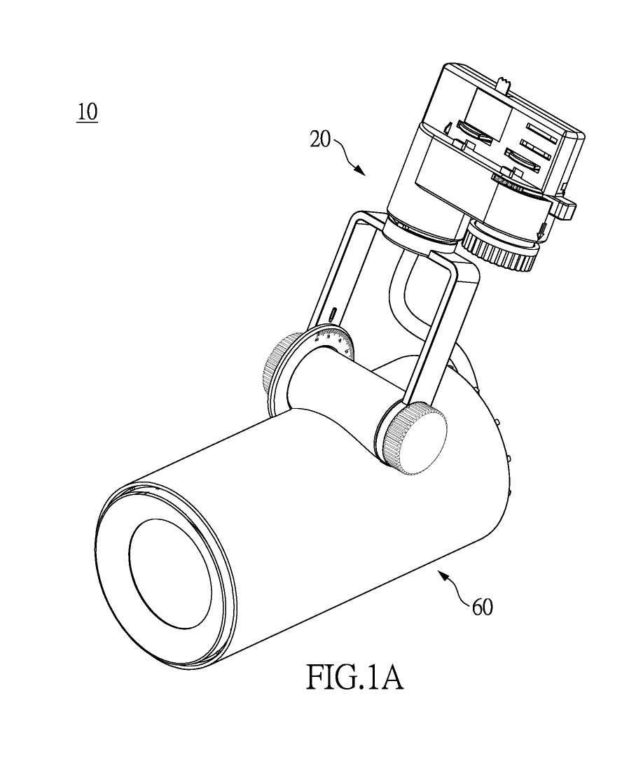

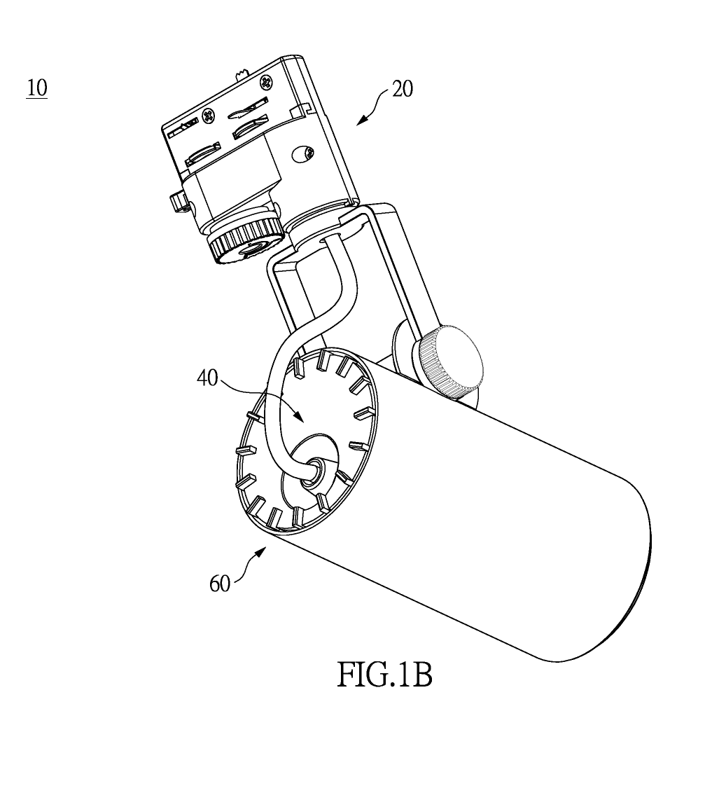

FIG. 1A shows a perspective drawing of one side of an LED lighting system of one embodiment in the instant disclosure. The LED lighting system 10 has a clamp 20, a base 40 (shown in FIG. 1B) and a lamp holder 60. The clamp 20 can be installed on the ceiling or on the wall in a room or a space. By being clamped by the clamp 20, the lamp holder 60 is installed on the ceiling or one the walls. FIG. 1B shows a perspective drawing of another side of an LED lighting system of one embodiment in the instant disclosure. FIG. 1B shows the position where the base 40 is configured. The clamp 20 clamps the lamp holder 60 such that the lamp holder 60 can rotate by different rotation angles, so as to emit light from different angles.

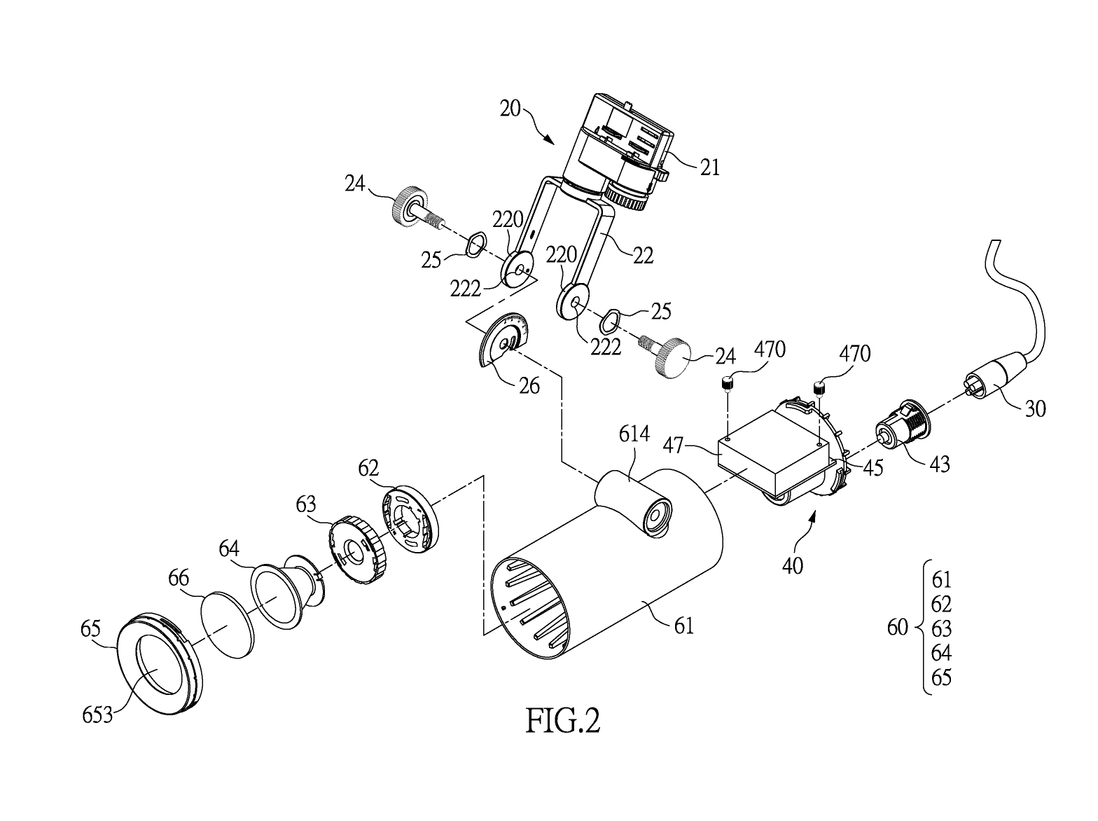

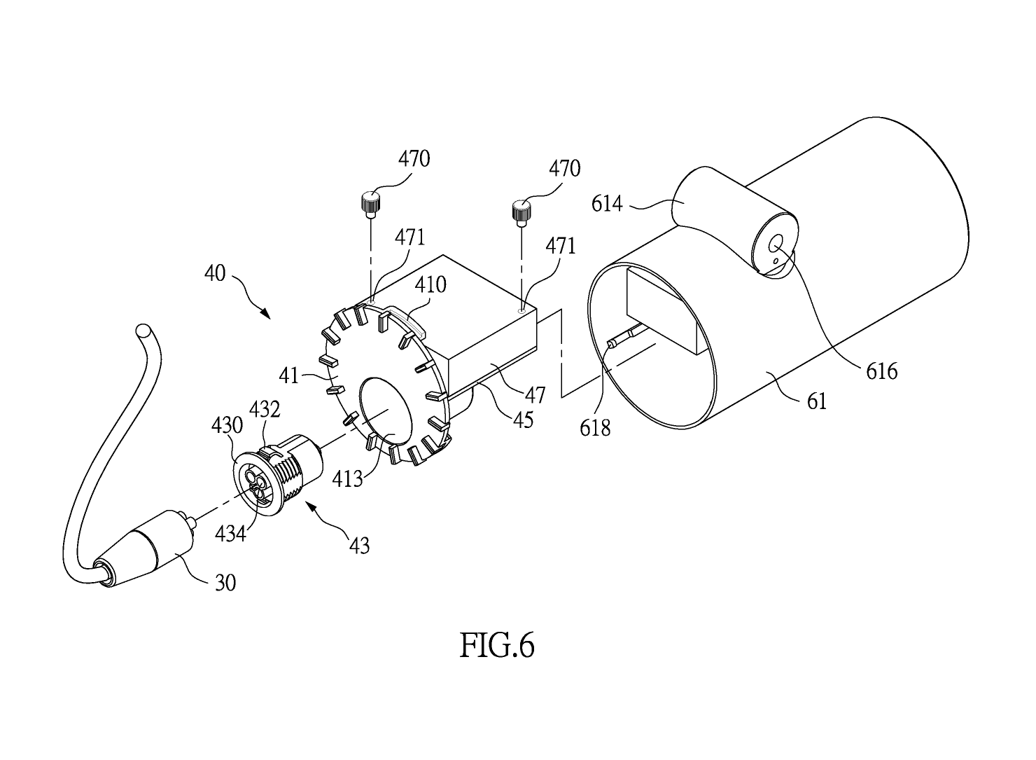

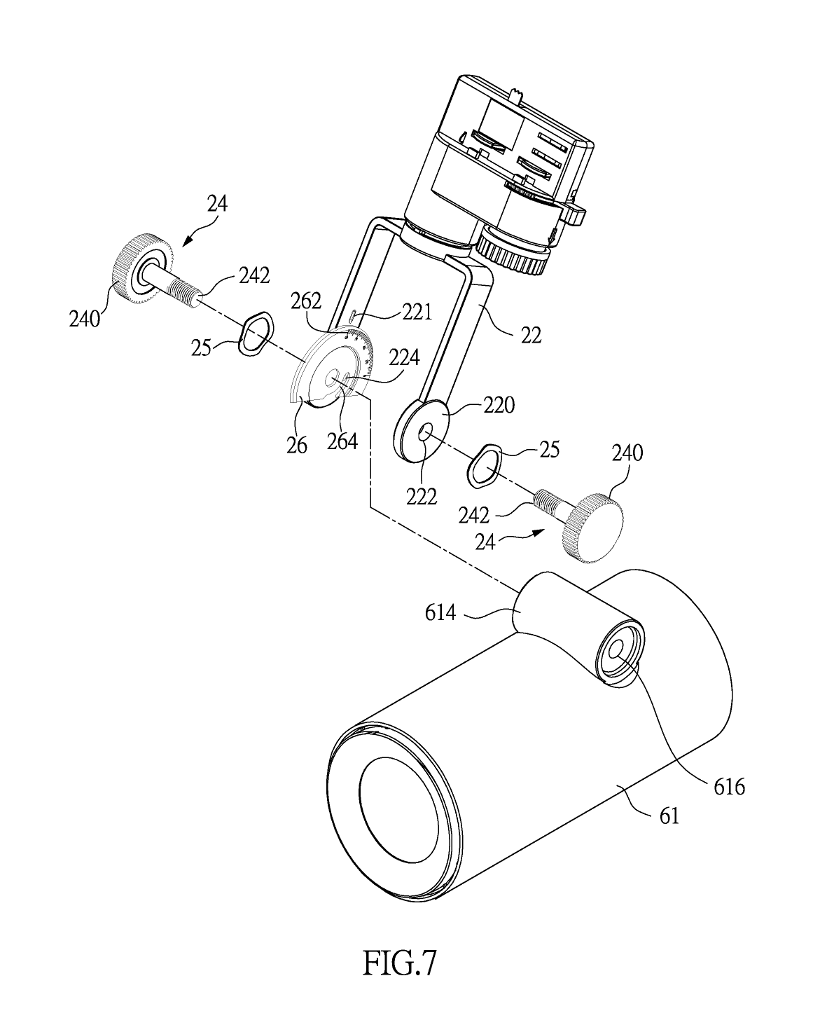

FIG. 2 shows a three-dimensional exploded view of an LED lighting system of one embodiment in the instant disclosure. FIG. 2 shows the elements that the clamp 20, base 40 and lamp holder 60 are composed of. The clamp 20 comprises a connecting member 21, a lamp support 22, a pair of locking pieces 24 and a clamping piece. The connecting member 21 is configured at the top of the lamp support 22 of the clamp 20, connected to the application side, such as the ceiling or the wall, and electrically connected to a commercial power source. A quick connector 30 is configured to extend from the connecting member 21, to supply power to the LED lighting system. Other related descriptions of the lamp support 22 and the locking piece 24 are shown by FIG. 7. The base 40 comprises a base plate 41, a base connecting part 43, an electric connecting part 45 and a driver 47. The base connecting part 43 accommodates the quick connector 30, and is electrically connected to the driver 47. The related descriptions of the base 40 are shown by FIG. 6. The lamp holder 60 shown in FIG. 2 comprises a heat dissipator 61, a back cover 62, an LED module 63, an optical module 64, a front cover 65 and a diffusion plate 66. The heat dissipator 61 has a first carrying part, a second carrying part and a first receiving part. A light emitting device is composed of the back cover 62, the LED module 63, the optical module 64 and the front cover 65. The light emitting device has a first fastening structure to fasten the first carrying part. The lamp support 22 has a locking part to lock the first receiving part. The base 40 has a second fastening structure to fasten the second carrying part.

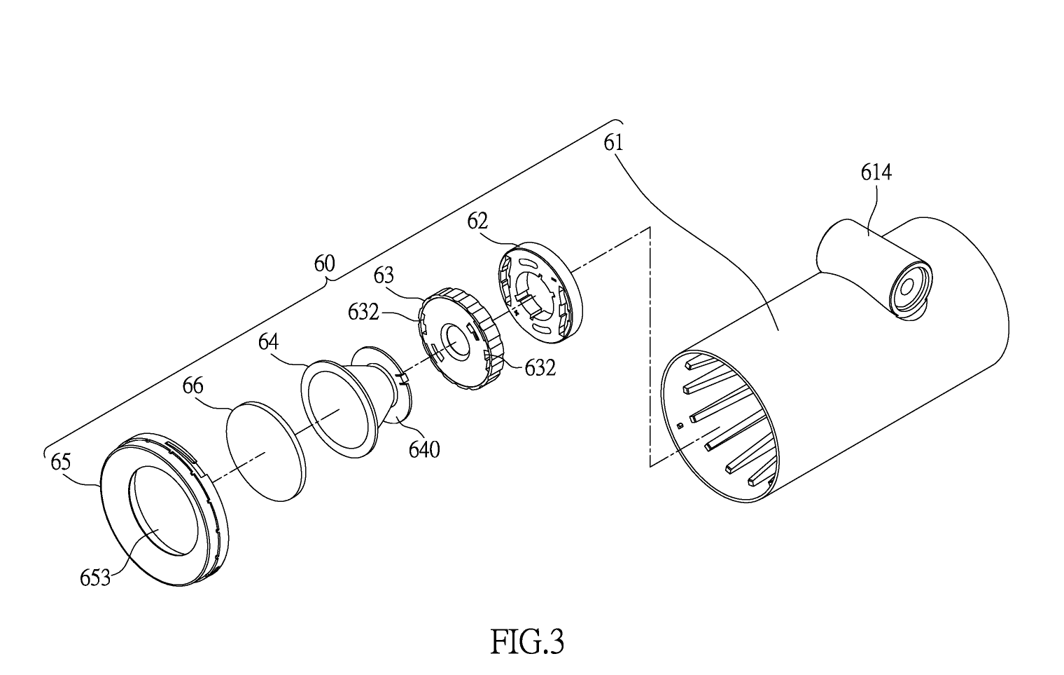

Refer to FIG. 3. FIG. 3 shows an exploded view of a lamp holder of an LED lighting system of one embodiment in the instant disclosure. As shown in FIG. 3, the back cover 62 supports the LED module 63 by assembling the back cover 62 with the LED module 63, and assembling the optical module 64 in the LED module 63. The combination of the LED module 63, the back cover 62 and the optical module 64 is installed in the heat dissipator 61 and covered by the front cover 65. The optical module 64 is configured toward a main light-emitting direction. In other words, the heat dissipator 61 is hollow for accommodating the combination of the LED module 63, the back cover 62 and the optical module 64, and in practice, there may be additionally a diffusion plate 66 configured between the optical module 64 and the front cover 65. The front cover 65 is ring-shaped, and there is a widow 653 formed inside the front cover 65 to emit the light. The optical module 64 is trumpet-shaped to reflect the light emitted by the LED module 63 for increasing the luminosity. A ring-shaped plate 64 is configured at the position where the back end of the optical module 64 is connected to the LED module 63, as shown in FIG. 3. A plurality of symmetrical third slots 632 are configured in the corresponding LED module 63. The plate 640 makes the optical module 64 and the LED module 63 connect via the third slots 632 of the LED module 63. Thereby, the user can manually screw the plate 640 of the optical module 64 into the third slot 632 to assemble the optical module 64 and the LED module 63 together.

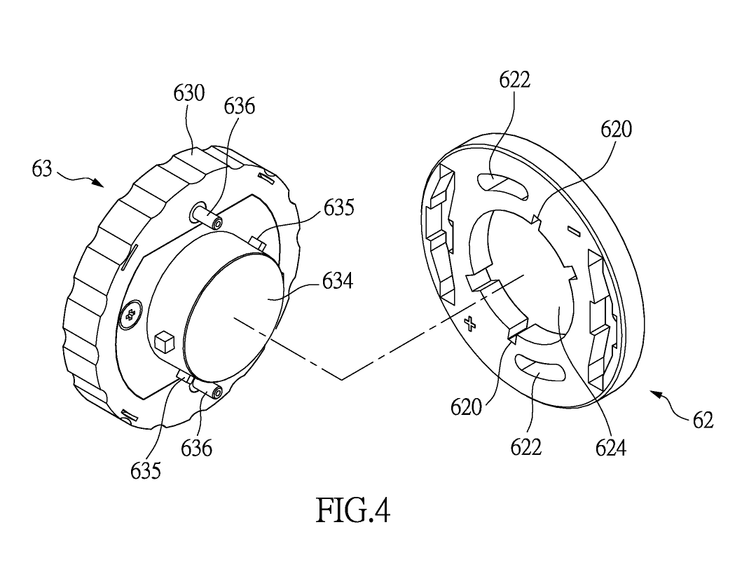

FIG. 4 shows an assembly diagram for a back cover and an LED module of one embodiment in the instant disclosure. As shown in FIG. 4, the LED module 63 comprises a revolvable shell 630, a light emitting element 634, a pair of pillar plugs 636 and a pair of convex protrusions 635 configured at the side of the light emitting element 634. A pair of the concave slots 620 and a pair of pillar sockets 622 are configured on the back cover 62. When the LED module 63 is under the back cover 62, the convex protrusions 635 can be correspondingly inserted into the concave slots 620 such that the LED module 63 and the back cover 62 can be assembled together. In other words, by manually inserting the pillar plugs 636 into the pillar sockets 622 and rotating the revolvable shell 630, the convex protrusions 635 can fasten the back cover 62, so that the LED module 63 and the back cover 62 are combined. As shown in FIG. 4, the pillar socket 622 is arc-shaped, so that the pillar socket 622 can provide room for the displacement of the pillar plug 636 when the pillar plug 636 is inserted into the pillar socket 622 and the revolvable shell 630 is rotating. The light emitting element 634 is electrically connected to the driver 47 (shown in FIG. 2), and the driver 47 supplies power to the light emitting element 634.

The back cover 62 has an opening 624 to accommodate the light emitting element 634 of the LED module 63 such that the air flows convectively through the opening 624 and the heat dissipator 61.

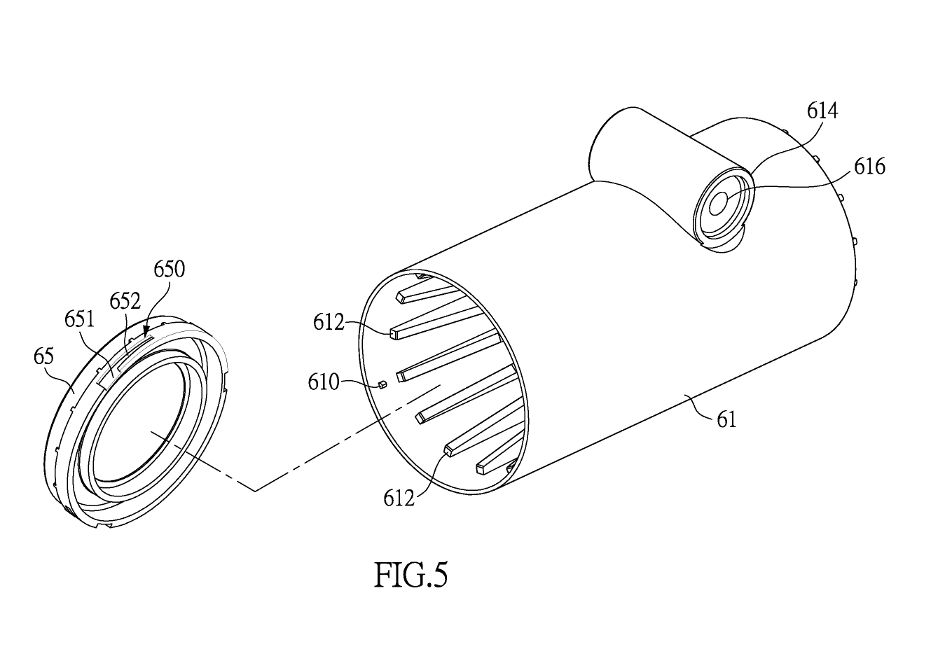

FIG. 5 shows an assembly diagram for a heat dissipator and a front cover of one embodiment in the instant disclosure. As shown in FIG. 5, at least one front-end projection 610 is configured on the first carrying part, and at least one first slot 650 corresponding to the front-end projection 610 is configured on the first fastening structure. The first slot 650 makes the light emitting device fasten in the heat dissipator 61 via the front-end projection 610. The front cover 65 has a window 653, and the front cover 65 can cover the back cover 62 to form a containing space accommodating the LED module 63 and the optical module 64. The first slot 650 is configured outside the region where the front cover 65 covers the back cover 62. In other words, a plurality of first slots 650 are configured at the side of the front cover 65. A notch portion 651 and a slit portion 652 are configured within each first slot 650, and a plurality of front-end projections 610 are correspondingly configured at the inner side of the front end of the heat dissipator 61. By aligning the notch portion 651 of the first slot 650 to the front-end projection 610, manually inserting the front cover 65 into the heat dissipator 61 and rotating the front cover 65, the front-end projection 610 can enter into the slit portion 652, and the front-end projection 610 of the heat dissipator 61 can make the front cover 65 fasten to the heat dissipator 61 via the notch portion 651 and the slit portion 652. Thereby, the front cover 65 and the heat dissipator 61 can be assembled together. A plurality of heat dissipating fins 614 are configured inside the heat dissipator 61 to spread the heat generated when the light emitting element 634 emits light. A tube 614 is configured at one side of the heat dissipator 61, the locking concave cavity 616 is configured at two sides of the tube 614 to make the tube 614 combine with the clamp 20, and other related descriptions are shown by FIG. 7.

FIG. 6 shows an assembly diagram for a heat dissipator and a base plate of one embodiment in the instant disclosure. As shown in FIG. 6, the base 40 comprises the base plate 41, the base connecting part 43 and the electric connecting part 45. The base plate 41 has a second fastening structure and a base hole 413. The base hole 413 is formed by inwardly extending the outer part of the base plate 41, which is barrel-shaped, to accommodate the base connecting part. The quick connector 30 plugs into the base connecting part 43, wherein the base connecting part 43 has a connecting convex protrusion 430 and a connecting hole 432. The connecting convex protrusion 430 is connected to the base hole 413, and the electric connecting part 745 is connected to the connecting hole 432. The base connecting part 43 has a plugging member 434 for the plugging of the quick connector 30. The electric connecting part 45 is configured at the inner side of the base plate 41 to carry the driver 47. A plurality of threaded holes (not shown), corresponding to the threaded holes 471 of the driver 47, are configured on the electric connecting part 45. When the driver 47 is assembled on the electric connecting part 45 and the threaded holes 471 of the driver 47 and the threaded holes of the electric connecting part 45 are aligned, by manually screwing the screw pieces 470 into the threaded holes, the driver 47 can be installed on the electric connecting part 45. At least one back-end projection 618 is configured on the second carrying part, and at least one second slot 410 corresponding to the back-end projection 618 is configured on the second fastening structure. The second slot 410 makes the base 40 fasten in the heat dissipator 61 via the back-end projection 618. In other words, a plurality of second slots 410 are configured at the side of the base plate 41, and a plurality of back-end projections 618 are correspondingly configured at the inner edge of the back end of the heat dissipator 61. By aligning the back-end projection 618 with the breach of the second slot 410 and by manually rotating the base plate 41, the base plate 41 of the base 40 can be combined with the heat dissipator 61.

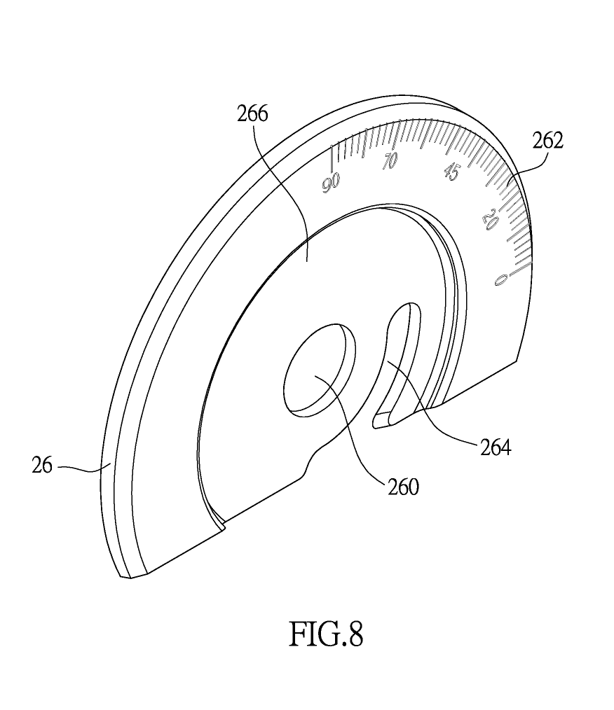

FIG. 7 shows an assembly diagram for a clamp and a lamp holder of one embodiment in the instant disclosure. FIG. 7 further illustrates the assembling structure of the lamp support 22, the locking pieces 24 and the clamping piece 26. FIG. 8 shows a perspective drawing of a clamping piece of an LED lighting system of one embodiment in the instant disclosure. The lamp support 22 shown in FIG. 7 is [symbol] -shaped.

Two extending portions 220 vertically extend downward from two ends of the lamp support 22 respectively. The end of the extending portion 220 has a locking hole 222, and the extending portion 220 is ring-shaped. The clamping piece 26 is attached at the inner side of one of the extending portions 220, and is rotatable around the locking hole 222 of the extending portion 220.

The clamping piece 26 shown in FIG. 8 comprises a round hole 260, a scale 262, a sliding groove 264 and a round concave cavity 266. The round hole 260 of the clamping piece 26 is aligned with the locking hole 222 on the extending portion 220. The scale 262 shows the rotating angle of the clamping piece 26. The sliding groove 264 controls the rotating angle of the clamping piece 26. A circular slot 224, corresponding to the locking hole 222, is configured on the surface of the sliding groove 264 for inserting in a fixing piece (not shown), so that the lamp holder 60 can be fixed at certain angle. The round concave cavity 266 corresponds to a side edge of the tube 64 of the heat dissipator 61. A pointer 221 is configured at the inner side of the lamp support 22 where the clamping piece 26 is positioned, to indicate the rotating angle of the lamp holder 60. The scale 262 shows the scaling of a certain angle range.

Each locking piece 24 comprises a screwing member 240 and a locking member 242. The locking pieces are symmetrically assembled. At least one locking concave cavity 616 is configured on the first receiving part, and at least one locking piece 24 and one locking hole 222, corresponding to the locking concave cavity 616, are configured on the locking part. The locking piece 24 locks the lamp support 22 to the heat dissipator 61 via the locking hole 222 and the locking concave cavity 616. The clamping piece 26 is configured between the lamp support 22 and the heat dissipator 61 by making the locking piece 24 pass through the round hole 260 of the clamping piece 26. Specifically, the locking concave cavities 616 at two sides of the tube 614 on the heat dissipator 61 are aligned with the locking holes 222 of the two extending portions 220 of the lamp support 22. The shape of the round concave cavity 266 of the clamping piece 26 fits the side edge of the tube 614 so as to accommodate the tube 614. When holding the screwing member 240 of the locking pieces 24, the user can manually make the locking member 242 of the locking pieces 24 screw into the locking concave cavities 616. Thereby, the heat dissipator 61 can be assembled into the lamp support 22, and the lamp holder 60 and the lamp holder 20 can be combined together. Preferably, a pad 25 is configured between the locking piece 24 and the extending portion 220 for locking tightly. By manually inserting the quick connector into the base connecting part 43 accommodated by the base hole 413 of the base plate 41, the assembly of the LED lighting system is completed without assistance of tools.

To sum up, in the LED lighting system provided by the instant disclosure, the assembly of the clamp 20 and the lamp holder 60, and the assembly of the lamp holder 60 and the base 40 can be completed by manually rotating and plugging the elements. Moreover, the assemblies of the heat dissipator 61 and the front cover 65, the LED module 63 and the back cover 62, the LED module 63 and the optical module 64, and the driver 47 and the electric connecting part can also be completed by manually rotating and plugging the elements. Thereby, the user needs to use no more tools to disassemble and assemble the elements of LED lighting system, which provides actual convenience for the user.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A LED lighting system, comprising:
a heat dissipator, having a first carrying part, a second carrying part and a first receiving part;
a light emitting device, having a first fastening structure to fasten the first carrying part;
a lamp support having a locking part to lock the first receiving part; and
a base, having a second fastening structure to fasten the second carrying part.

2. The LED lighting system according to claim 1, wherein at least one front-end projection is configured on the first carrying part, at least one first slot corresponding to the front-end projection is configured on the first fastening structure, and the first slot makes the light emitting device fixed in the heat dissipator via the front-end projection.

3. The LED lighting system according to claim 1, wherein at least one back-end projection is configured on the second carrying part, at least one second slot corresponding to the back-end projection is configured on the second fastening structure, and the second slot makes the base fixed in the heat dissipator via the back-end projection.

4. The LED lighting system according to claim 1, wherein at least one locking concave cavity breaks through the first receiving part, the locking part has at least one locking piece and one locking hole corresponding to the locking concave cavity, and the locking piece makes the lamp support locked to the heat dissipator via the locking hole and the locking concave cavity.

5. The LED lighting system according to claim 2, wherein the light emitting device comprises:
an LED module, having at least one third slot;
a back cover, supporting the LED module;
an optical module, configured toward a main light-emitting direction; and
a front cover, having a window, wherein the front cover covers the back cover to form a containing space accommodating the LED module and the optical module, and the first slot is configured outside the region where the front cover covers the back cover.

6. The LED lighting system according to claim 5, wherein the LED module has a light emitting element, a convex protrusion is configured on a side of the light emitting element, and a concave cavity corresponding to the convex protrusion is configured on the back cover such that the back cover is fastened on the LED module.

7. The LED lighting system according to claim 5, wherein a plate is configured on a back end of the optical module, and the plate makes the optical module fastened on the LED module via the third slot of the LED module.

8. The LED lighting system according to claim 5, wherein a notch portion and a slit portion are configured within each first slot of the front cover, and the front-end projection of the heat dissipator fastens the front cover onto the heat dissipator via the notch portion and the slit portion.

9. The LED lighting system according to claim 6, wherein the back cover has an opening to accommodate the light emitting element of the LED module such that the air flows convectively through the opening and the heat dissipator.

10. The LED lighting system according to claim 3, wherein the base comprises:
a base plate, having the second fastening structure and a base hole;
a base connecting part, having a connecting convex protrusion and a connecting hole, the connecting convex protrusion connecting to the base hole;
an electric connecting part, connecting to the connecting hole; and
a driver, configured to the electric connecting part.

11. The LED lighting system according to claim 10, wherein the back-end projection of the heat dissipator makes the base plate fastened to the heat dissipator via the second slot of the base plate.

12. The LED lighting system according to claim 10, wherein the base connecting part has a plugging member.

13. The LED lighting system according to claim 10, wherein a plurality of threaded holes are configured on the electric connecting part, and a plurality of screw pieces corresponding to the threaded holes are configured on the electric connecting part, to lock the driver to the electric connecting part.

14. The LED lighting system according to claim 4, wherein the lamp support has at least one pad, and the locking piece passes through the pad and locks in the locking concave cavity of the heat dissipator.

15. The LED lighting system according to claim 4, wherein the lamp support has a connecting member at the top of the lamp support to connect to an application side.

16. The LED lighting system according to claim 4, wherein two extending portions vertically extend from two sides of the top of the lamp support respectively, and one end of the extending portion has the locking hole.

17. The LED lighting system according to claim 4, wherein each locking piece has a screwing member and a locking member.

18. The LED lighting system according to claim 4, wherein the lamp support has a clamping piece, and the clamping piece has a round hole and is configured between the lamp support and the heat dissipator by making the locking piece lock into the round hole of the clamping piece.

19. A LED lighting system, comprising:
a clamp, comprising:
a locking piece;
a lamp support, having two extending portions, one end of each extending portion having a locking hole; and
a clamping piece, configured at the inner side of one of the ends of the extending portions, having a round hole;
a lamp holder, comprising:
a heat dissipator, having a tube, two locking concave cavities respectively configured at two sides of the tube, the heat dissipator having a plurality of the front-end projections; and
a light emitting device, having a plurality of first slots connected and fastened to the front-end projections, such that the light emitting device is accommodated within the heat dissipator; and
a base, configured at the bottom of the lamp holder;
wherein the locking pieces lock into the locking holes of the extending portions and pass through the round holes of the clamping piece, and a user manually locks the locking pieces into the two locking concave cavities respectively, such that the clamp supports the lamp holder and the clamping piece controls the rotation angle of the lamp holder.

20. A LED lighting system, comprising:
a clamp, comprising:
a lamp support, two extending portions vertically extending downward from its two ends respectively, each extending portion having a locking hole;
a clamping piece, having a round hole, configured at the inner side of one of the ends of the lamp support, wherein the round hole of the round hole corresponds to the locking hole of the extending portion of the lamp support, and the clamping piece is rotatable around the locking hole of the extending portion;
a locking piece, correspondingly passing through the locking hole; and
a quick connector, supplying power to the LED lighting system;
a lamp holder, comprising:
a LED module;
a back cover, fastened to the LED module by manually inserting the LED module into the back cover and rotating the LED module;
an optical module, connecting to the LED module by manually screwing the optical module into the LED module;
a heat dissipator, accommodating the LED module, wherein a tube is configured at one side of the outer ring of the heat dissipator, and two locking concave cavities are respectively configured at two sides of the tube; and
a front cover, fastened to the front end of the heat dissipator by manually connecting the front cover to the front end of the heat dissipator and rotating the front cover;
a base, comprising:
a base plate, fastened to the back end of the heat dissipator by manually rotating the base plate, the base plate having a base hole;
a base connecting part, having a connecting convex protrusion and a connecting hole, the connecting convex protrusion connecting to the base hole, the base connecting part accommodating the quick connector;
an electric connecting part, connected to the connecting hole; and
a driver, configured on the electric connecting part, electrically connected to the base connecting part and the LED module to make the LED module emit light;
wherein the clamping piece controls the rotation angle of the lamp holder.
